(19) United States
(12) Patent Application Publication
(10) Pub. No.: US 2003/0107015 A1
(43) Pub. Date: Jun. 12, 2003

(54) Method for estimating the position and the velocity of an EMVA armature

(75) Inventors: Lawrence A. Mianzo, Plymouth, MI (US); Ibrahim Haskara, Brownstown, MI (US)

Correspondence Address: Steven L. Oberholtzer, BRINKS HOFER GILSON & LIONE, P.O. Box 10395, Chicago, IL, 60610, US

(73) Assignee: Visteon Global Technologies, Inc

(21) Appl. No.: 10/198,702

(22) Filed: Jul. 17, 2002

Related U.S. Application Data
(60) Provisional application No. 60/339,418, filed on Dec. 11, 2001.

(51) Int. Cl. F16K 31/02

(52) U.S. Cl. 251/129.04; 137/554; 123/90.11

(57) ABSTRACT

A method is disclosed and claimed for estimating the position and the velocity of a valve armature in an electromagnetic valve actuation system, which includes a first solenoid coil that energizes and attracts the valve armature based on a first solenoid command. The method includes obtaining a parameter for the first solenoid command, measuring a property of the first solenoid coil, and estimating the position and the velocity of the valve armature based on the obtained parameter and the measured property.

### CROSS-REFERENCE TO RELATED APPLICATIONS

The present invention claims priority to U.S. Provisional Application Ser. No. 60/339,418 entitled “High-bandwidth (sensorless) soft seating control of an electromagnetic valve actuator system”, filed Dec. 11, 2001, and incorporated in its entirety by this reference.

### TECHNICAL FIELD

This invention relates generally to the valve actuation field and, more specifically, to a method for estimating the position and the velocity of a valve armature in an electromagnetic valve actuator system.

### BACKGROUND

In a conventional engine of a typical vehicle, a valve is actuated from a closed position against a valve seat to an open position at a distance from the valve seat to selectively pass a fluid, such as a fuel and air mixture, into or out of a combustion chamber. Over the years, several advancements in valve actuations, such as variable valve timing, have improved power output, fuel efficiency, and exhaust emissions. Variable valve timing is the method of actively adjusting either the duration of the close or open cycle, or the timing of the close or open cycle of the valve. Several automotive manufacturers, including Honda and Ferrari, currently use mechanical devices to provide variable valve timing in their engines.

A more recent development in the field of variable valve timing is the use of two solenoid coils located on either side of an armature to open and close the valve heads. Activation of one of the solenoid coils creates an electromagnetic attractive force on the armature, which moves the valve in one direction toward the active coil. Activation of the opposing solenoid coil creates an electromagnetic attractive force on the armature toward the opposing active coil, which moves the valve in the other direction. This system, also known as electromagnetic valve actuator (or “EMVA”), allows for an continuous variability for the duration and timing of the open and close cycles, which promises even further improvements in power output, fuel efficiency, and exhaust emissions.

In an engine, it is desirable to swiftly move the valve between the open position and the closed position and to “softly seat” the valve against the valve seat. The force created by the EMVA, which is related to the distance between the solenoid coil and the armature and the applied coil activation current, increases non-linearly as the armature approaches the solenoid coil. In fact, the solenoid coil can forcefully slam the armature against the solenoid coil, which may also forcefully slam the valve head into the valve seat. The slamming of the valve against the valve seat, or the slamming of the armature against the solenoid coils, causes undesirable noise, vibration, and harshness (“NVH”) within the vehicle.

U.S. patent application Ser. No. 10/109,350, which is hereby incorporated in its entirety by this reference, teaches a method of controlling an EMVA to minimize NVH. The method is partially dependent on the position and the velocity of the armature. While the position of the armature may be measured by a position sensor, the incorporation of a position sensor into the EMVA is relatively expensive. Thus, there is a need in the automotive industry to create a method for estimating the position and the velocity of the valve armature without a position sensor.

### BRIEF DESCRIPTION OF THE FIGURES

FIGS. 1A, 1B, and 1C are cross-sectional views of an electromagnetic valve actuator used in the preferred methods.

### DESCRIPTION OF THE PREFERRED EMBODIMENTS

The following description of the two preferred methods of the invention is not intended to limit the invention to these preferred methods, but rather to enable a person skilled in the art to make and use this invention.

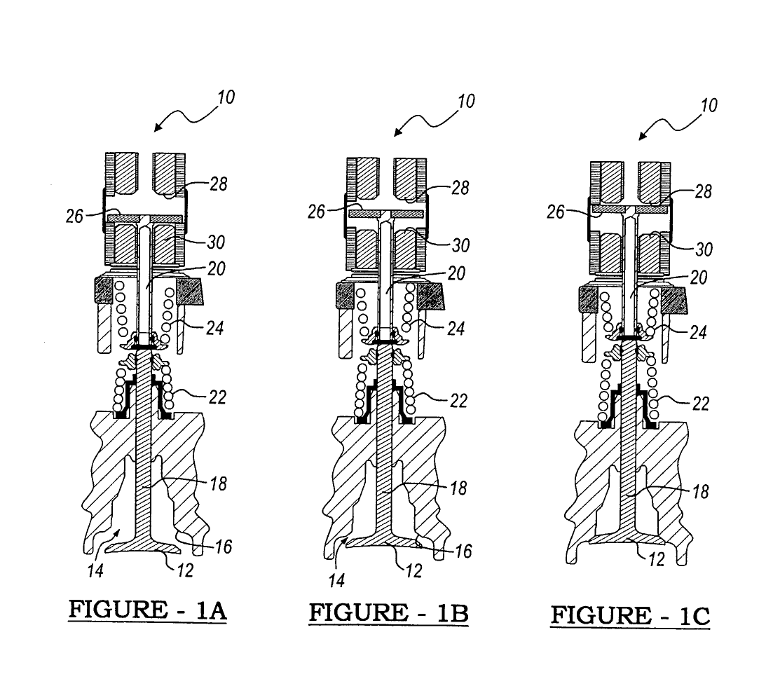

As shown in FIGS. 1A, 1B, and 1C, the preferred methods of the invention can be used to control an electromagnetic valve actuator 10 (“EMVA”) of an engine of a vehicle. The preferred methods may also be used to control an EMVA 10 of other suitable devices, such as an engine of a watercraft, an engine of an aircraft, or other fluid actuating systems.

The EMVA 10 used in the preferred methods includes a valve head 12 that moves between an open position (shown in FIG. 1A) and a closed position (shown in FIG. 1C). The valve head 12 functions to selectively pass fluid through an orifice 14 by moving from a closed position to an open position. Preferably, the valve head 12 selectively moves a distance from the orifice 14, which allows the passage of a fuel and air mixture into a combustion chamber of an engine (only partially shown), and then moves against a valve seat 16 around the orifice 14 to block the passage of the fuel and air mixture.

The EMVA 10 used in the preferred methods also includes a valve stem 18, an armature stem 20, a first spring 22, and a second spring 24. The valve stem 18 functions to actuate the valve head 12 from a location remote from the orifice 14. The armature stem 20, the first spring 22, and the second spring 24 collectively cooperate with the valve stem 18 to substantially negate the effects of temperature changes on the EMVA 10. The first spring 22 biases the valve stem 18 toward the armature stem 20, while the second spring 24 biases the second valve stem toward the valve stem 18. In this manner, the valve stem 18 and the armature stem 20 substantially act as one unit during the movement of the valve head 12, but allow for the elongation of the valve stem 18 caused by temperature fluctuations within the engine. In addition to providing forces to bias the valve stem 18 and the armature stem 20 together, the first spring 22 and the second spring 24 are preferably designed to bias the valve head 12 into an equilibrium position or “middle position” (shown in FIG. 1B) between the open position and the closed position.

The EMVA 10 used in the preferred methods also includes a valve armature 26 coupled to the valve head 12 through the armature stem 20 and the valve stem 18, a first solenoid coil 28 located on one side of the armature 26, and a second solenoid coil 30 located on the other side of the valve armature 26. Preferably, the valve armature 26 extends from the armature stem 20 with a rectangular, cylindrical, or other appropriate shape and includes a magnetizable and relatively strong material, such as steel. The first solenoid coil 28 functions to create an electromagnetic force on the valve armature 26 to move the valve head 12 into the closed position, while the second solenoid coil 30 functions to create an electromagnetic force on the valve armature 26 to move the valve head 12 into the open position.

The EMVA 10 used in the preferred methods also includes an input commander (not shown), which functions to alternatively activate the solenoid coils to move the valve head 12 from open position, through the middle position, and into the closed position and to move the valve head 12 from the closed position, through the middle position, and into the open position. The input commander preferably allows for the continuous operation of the valve head 12 with a cycle time of about 3 milliseconds, depending on the spring constants, the distance of armature travel, and the mass of the elements, amongst other factors.

The preferred methods of estimating the position and the velocity of the armature include: obtaining a parameter for the first solenoid command and the second solenoid command, measuring a property of the first solenoid coil 28 and the second solenoid coil 30, and estimating the position and the velocity of the valve armature 26 based on the obtained parameter for the first solenoid command, the obtained parameter for the second solenoid command, the measured property of the first solenoid coil 28, and the measured property of the second solenoid coil 30. The preferred methods may further include other acts as described below or as envisioned by a skilled person in the art.

The first preferred method of the invention includes obtaining input voltage and measuring current at the solenoid coils. This method, which includes a four state observer, may be reduced to a three state observer if the first solenoid coil and the second solenoid coil are not operated simultaneously. The second preferred method of the invention, which includes a two state observer, includes obtaining input current and measuring flux at the solenoid coils. An observer is a well known method from control systems literature that reconstructs unmeasured parameters or states from measured parameters or states. An observer is typically composed of two components: a model replication component and a feedback correction term based on the error between the measured and estimated state.

In the first preferred method, the first step of obtaining a parameter preferably includes obtaining input voltage for the first solenoid command and the second solenoid command. Obtaining input voltage is preferably accomplished by either measuring input voltage with a suitable sensor or calculating input voltage based on the solenoid commands with a suitable processor. Obtaining input voltage may alternatively be accomplished with other suitable devices or methods. The second step of measuring a property includes measuring current at the first solenoid coil and the second solenoid coil. Measuring current at the solenoid coils is preferably accomplished with a current sensor with a differential amplifier that outputs a voltage proportional to the current, but may alternatively be accomplished with any suitable device or method.

In first preferred method, the third step of estimating the position and the velocity of the valve armature preferably uses a model of the EMVA based on the following four first order nonlinear ordinary differential equations:

$$\begin{matrix}{\dot{x}}_{1} = {x}_{2} \\ {\dot{x}}_{2} = \frac{1}{m} \times [ - {cx}_{2} - {kx}_{1} + {f}_{em} ( {x}_{1} , {x}_{3} , {x}_{4} ) - {f}_{e} ] \\ {\dot{x}}_{3} = \frac{1}{[ {L}_{oc} + \frac{\partial {Ψ}_{oc} ( {x}_{1} , {x}_{3} )}{\partial {x}_{3}} ]} \times [ {u}_{1} - {R}_{oc} {x}_{3} - \frac{\partial {Ψ}_{oc} ( {x}_{1} , {x}_{3} )}{\partial {x}_{1}} {x}_{2} ] \\ {\dot{x}}_{4} = \frac{1}{[ {L}_{cc} + \frac{\partial {Ψ}_{cc} ( {x}_{1} , {x}_{4} )}{\partial {x}_{4}} ]} \times [ {u}_{2} - {R}_{cc} {x}_{4} - \frac{\partial {Ψ}_{cc} ( {x}_{1} , {x}_{4} )}{\partial {x}_{1}} {x}_{2} ]\end{matrix}$$

The four states include: x₁, the position of the valve armature; x₂, the velocity of the valve armature; x₃, the current of the first solenoid coil; and x₄, the current of the second solenoid coil. The parameter for the solenoid commands include: u₁ and u₂, the input voltages of the first solenoid coil and the second solenoid coil, respectively. Other elements of the equation include: c, the damping; k, the effective spring stiffness; m, the effective moving mass of the valve armature, the valve head, a portion of the first and second springs, the spring keepers and lash caps, the armature stem, and the valve stem; R_{oc} and R_{cc}, the resistance of the respective solenoid coils; L_{oc} and L_{cc}, the inductance of the respective solenoid coils; ψ_{oc} and ψ_{cc}, the magnetic flux of the respective solenoid coil; fₑₘ, the magnetic force acting on the valve armature; and fₑ, the engine load disturbance acting on the EMVA. The damping and stiffness of the model are represented as linear, but may alternatively be represented as non-linear. Further, the equations preferably include several simplifications, including the omission of saturation of the armature position and eddy current losses, but may alternatively include further simplifications. By solving for the four states, the position and the velocity of the valve armature can be estimated from the input voltage for the first solenoid command, the input voltage for the second solenoid command, the measured current at the first solenoid coil, and the measured current at the second solenoid coil. The position and the velocity of the valve armature may, of course, be estimated from the input voltages and the measured currents with other suitable models or equations.

In the second preferred method, the first step of obtaining a parameter includes obtaining input current for the first solenoid command and the second solenoid command. Obtaining input current is preferably accomplished by either measuring input current with a suitable current sensor or calculating input current based on the solenoid command with a suitable processor. Obtaining input current may alternatively be accomplished with other suitable devices or methods. The second step of measuring a property includes measuring flux at the first solenoid coil and the second solenoid coil. Measuring flux at the solenoid coils is preferably accomplished with a suitable sensor, such as a hall effect sensor, but may alternatively be accomplished with any suitable device or method.

In the second preferred method, the third step of estimating the position and the velocity of the valve armature preferably uses a model of the EMVA based on two equations similar to the first and second equations presented above. By solving for the two states, the position and the velocity of the valve armature can be estimated from the input current for the first solenoid command, the input current for the second solenoid command, the measured flux at the first solenoid coil, and the measured flux at the second solenoid coil. The position and the velocity of the valve armature may, of course, be estimated from the input currents and the measured fluxes with other suitable models or equations.

The preferred methods may also include a feedback correction term. The feedback preferably includes estimating the property of the first solenoid coil; calculating a first error based on the estimated property and the measured property of the first solenoid coil; estimating the property of the second solenoid coil; and calculating a second error based on the estimated property and the measured property of the second solenoid coil. The estimation of the position and the velocity of the valve armature is further based on the calculated first error and the calculated second error. This feedback of the calculated errors provides a correcting effect, which may increase accuracy of the estimation.

In the first preferred method, the feedback correction term preferably includes estimating the current of the first solenoid coil; calculating a first error based on the estimated current and the measured current at the first solenoid coil; estimating the current of the second solenoid coil; and calculating a second error based on the estimated current and the measured current at the second solenoid coil; wherein said estimating the position and the velocity of the valve armature is further based on the calculated first error and the calculated second error. The feedback loop of the first preferred method may, of course, be based on other suitable factors, equations, or models.

In the second preferred method, the feedback correction term preferably includes estimating the flux of the first solenoid coil; calculating a first error based on the estimated flux and the measured flux of the first solenoid coil; estimating the flux of the second solenoid coil; calculating a second error based on the estimated flux and the measured flux of the second solenoid coil; wherein said estimating the position and the velocity of the valve armature is further based on the calculated first error and the calculated second error. The feedback loop of the second preferred method may, of course, be based on other suitable factors, equations, or models.

Although the preferred methods of the invention have been described with respect to two solenoid coils, the preferred methods can be used with only the active coil of the first solenoid coil and the second solenoid coil. Using only the active coil reduces the observer order, complexity, and computational time. Further, although the preferred methods of the invention have been described with respect to one EMVA (an intake valve), the preferred methods can be used on multiple EMVAs (both intake valves and exhaust valves) within an engine.

As a person skilled in the art will recognize from the previous detailed description and from the figures and claims, modifications and changes can be made to the preferred methods of the invention without departing from the scope of this invention defined in the following claims.

We claim:

1. A method for estimating the position and the velocity of a valve armature in an electromagnetic valve actuation system, which includes a first solenoid coil that energizes and attracts the valve armature based on a first solenoid command, said method comprising:
obtaining a parameter for the first solenoid command;
measuring a property of the first solenoid coil; and
estimating the position and the velocity of the valve armature based on the obtained parameter and the measured property.

2. The method of claim 1 wherein said obtaining a parameter includes measuring a parameter for the first solenoid command.

3. The method of claim 1 wherein said obtaining a parameter includes calculating a parameter for the first solenoid command based on the first solenoid command.

4. The method of claim 1 further comprising:
estimating the property of the first solenoid coil; and
calculating an error based on the estimated property and the measured property;
wherein said estimating the position and the velocity of the valve armature is further based on the calculated error.

5. The method of claim 1 in an electromagnetic valve actuation system that includes a second solenoid coil that energizes and attracts the valve armature in an opposite direction based on a second solenoid command, said method further comprising:
obtaining a parameter for the second solenoid command;
measuring a property of the second solenoid coil; and
estimating the position and the velocity of the valve armature based on the obtained parameter for the first solenoid command, the obtained parameter for the second solenoid command, the measured property of the first solenoid coil, and the measured property of the second solenoid coil.

6. The method of claim 5 further comprising:
estimating the property of the first solenoid coil;
calculating a first error based on the estimated property and the measured property of the first solenoid coil;
estimating the property of the second solenoid coil; and
calculating a second error based on the estimated property and the measured property of the second solenoid coil;
wherein said estimating the position and the velocity of the valve armature is further based on the calculated first error and the calculated second error.

7. The method of claim 1 wherein said obtaining a parameter includes obtaining input voltage for the first solenoid command, wherein said measuring a property includes measuring current at the first solenoid coil; and wherein said estimating the position and the velocity of the valve armature is based on the input voltage and the measured current.

8. The method of claim 7 wherein said obtaining input voltage includes measuring input voltage.

9. The method of claim 7 wherein said obtaining input voltage includes calculating input voltage based on the first solenoid command.

10. The method of claim 7 further comprising:
estimating the current at the first solenoid coil; and
calculating an error based on the estimated current and the measured current;
wherein said estimating the position and the velocity of the valve armature is further based on the calculated error.

11. The method of claim 7 in an electromagnetic valve actuation system that includes a second solenoid coil that energizes and attracts the valve armature in an opposite direction based on a second solenoid command, said method further comprising:
obtaining input voltage for the second solenoid command;
measuring current at the second solenoid coil; and
estimating the position and the velocity of the valve armature based on the input voltage for the first solenoid command, the input voltage for the second solenoid command, the measured current at the first solenoid coil, and the measured current at the second solenoid coil.

12. The method of claim 11 further comprising:
estimating the current of the first solenoid coil;
calculating a first error based on the estimated current and the measured current at the first solenoid coil;
estimating the current of the second solenoid coil; and
calculating a second error based on the estimated current and the measured current at the second solenoid coil;
wherein said estimating the position and the velocity of the valve armature is further based on the calculated first error and the calculated second error.

13. The method of claim 1 wherein said obtaining a parameter includes obtaining input current for the first solenoid command, wherein said measuring a property includes measuring flux at the first solenoid coil; and wherein said estimating the position and the velocity of the valve armature is based on the input current and the measured flux.

14. The method of claim 13 wherein said obtaining input current includes measuring input current.

15. The method of claim 13 wherein said obtaining input current includes calculating input current based on the first solenoid command.

16. The method of claim 13 further comprising:
estimating the flux at the first solenoid coil; and
calculating an error based on the estimated flux and the measured flux;
wherein said estimating the position and the velocity of the valve armature is further based on the calculated error.

17. The method of claim 13 in an electromagnetic valve actuation system that includes a second solenoid coil that energizes and attracts the valve armature in an opposite direction based on a second solenoid command, said method further comprising:
obtaining input current for the second solenoid command;
measuring flux at the second solenoid coil; and
estimating the position and the velocity of the valve armature based on the input current for the first solenoid command, the input current for the second solenoid command, the measured flux at the first solenoid coil, and the measured flux at the second solenoid coil.

18. The method of claim 17 further comprising:
estimating the flux of the first solenoid coil;
calculating a first error based on the estimated flux and the measured flux of the first solenoid coil;
estimating the flux of the second solenoid coil;
calculating a second error based on the estimated flux and the measured flux of the second solenoid coil;
wherein said estimating the position and the velocity of the valve armature is further based on the calculated first error and the calculated second error.
